(19) United States
(12) Patent Application Publication
(10) Pub. No.: US 2004/0012628 A1
(43) Pub. Date: Jan. 22, 2004

(54) Device interface customization

(76) Inventors: Linn James Kropf, Boise, ID (US); Brett Green, Meridian, ID (US); Kram Henry Allen, Meridian, ID (US)

Correspondence Address: HEWLETT-PACKARD COMPANY, Intellectual Property Administration, P.O. Box 272400, Fort Collins, CO, 80527-2400, US

(21) Appl. No.: 10/198,335

(22) Filed: Jul. 16, 2002

(51) Int. Cl. G09G 5/00

(52) U.S. Cl. 345/744; 345/749

(57) ABSTRACT

The present disclosure relates to electrical device user interface customization. Systems and methods that facilitate such customization are disclosed. In one embodiment, a method for facilitating customization comprises receiving a device interface selection, and facilitating implementation of the selection such that a customized electrical device user interface is presented to a user when accessing the interface via a browser.

### FIELD OF THE INVENTION

The present disclosure relates to device interface customization. More particularly, the disclosure relates to systems and methods with which the arrangement of a device interface can be customized to suit user preferences or needs.

### BACKGROUND OF THE INVENTION

Many electrical devices designed for use with a host device such as a personal computer (PC) now have embedded servers that allow users to control the operation of the electrical devices. For instance, several printing devices include embedded servers with which the various settings of the device can be adjusted and/or viewed. With such an embedded server, users can access a user interface for the device using a conventional browser either via a network connection or through a direct connection.

The ability to access a user interface via a browser provides several advantages. First, the user can control the settings and operation of the electrical device remotely without having to physically approach and interact with the electrical device. Second, ease of use is increased in that the user interface accessed with the browser can be more detailed than any user interface that is presented by most electrical devices due to space limitations. In addition, due to the storage of the embedded server on the electrical device, less software needs to be downloaded onto the host device (e.g., PC) to access and control the electrical device.

Most embedded servers present static content to the user. That is, the look and feel of the user interface is fixed and therefore cannot be altered except, perhaps, by changing the electrical device's firmware, a task which is clearly beyond the capabilities of the typical end user.

Often, it would be useful to be able to change the arrangement and/or content of the user interface presented to the user with the embedded server. If customization were more easily achievable, the aesthetics of the user interface could be changed by the user to suit the user's tastes. Beyond merely being aesthetically unappealing to the user, the static content provided in existing user interfaces may be awkward to some users. For instance, most such user interfaces are North America-centric. Accordingly, the format typically is arranged such that flow is from left to right. This arrangement may be counterintuitive, and therefore difficult to follow, for users of countries in which information is normally provided in a right to left or top to bottom format. In some cases, a North America-centric format may even be offensive to some users.

Although limited customization facilities have been developed, such as mini-applications (e.g., Java applets™ or Hewlett-Packard Chailets™) that are configured to add content to a browser-based user interface, no facilities have been introduced that allow modification of an existing arrangement within an electrical device. Accordingly, it can be appreciated that it would be desirable to have systems and methods that permit a greater level of user interface customization than is presently available.

### SUMMARY OF THE INVENTION

The present disclosure relates to electrical device user interface customization. Systems and methods that facilitate such customization are disclosed. In one embodiment, a method for facilitating customization comprises receiving a device interface selection, and facilitating implementation of the selection such that a customized electrical device user interface is presented to a user when accessing the interface via a browser. By way of example, the receiving of a device interface selection can comprise receiving modifications to a style sheet, receiving a replacement style sheet, or receiving identification of a replacement style sheet.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 is a schematic view of an embodiment of a system through which device user interface customization can be obtained.

FIG. 2 is a block diagram of an embodiment of a computing device shown in FIG. 1.

FIG. 3 is a block diagram of an embodiment of an electrical device shown in FIG. 1.

FIG. 4 is a flow diagram that illustrates an embodiment of use of the system in customizing a device user interface.

FIG. 5 is a flow diagram that illustrates an embodiment of operation of a host-side customization utility in providing device user interface customization.

FIGS. 6 is an embodiment of a style sheet that can be used to customize a device user interface.

FIG. 7 is a schematic view of an embodiment of a customized device user interface.

FIG. 8 is a flow diagram that illustrates an embodiment of operation of a device-side customization utility in providing device user interface customization.

### DETAILED DESCRIPTION

Disclosed herein are systems and methods through which device user interfaces can be customized to suit the preferences or needs of the user. With these systems and methods, the user can download content and/or formatting information from a host device to the electrical device for which the user interface is provided. In other arrangements, the user can directly select and/or arrange content by accessing the electrical device.

To facilitate description of the invention, example systems are first discussed with reference to the figures. Although these systems are described in detail, it will be appreciated that these systems are provided for purposes of illustration only and that various modifications are feasible. After the example systems have been described, examples of operation of the systems are provided to explain the manners in which user interface customization can be achieved.

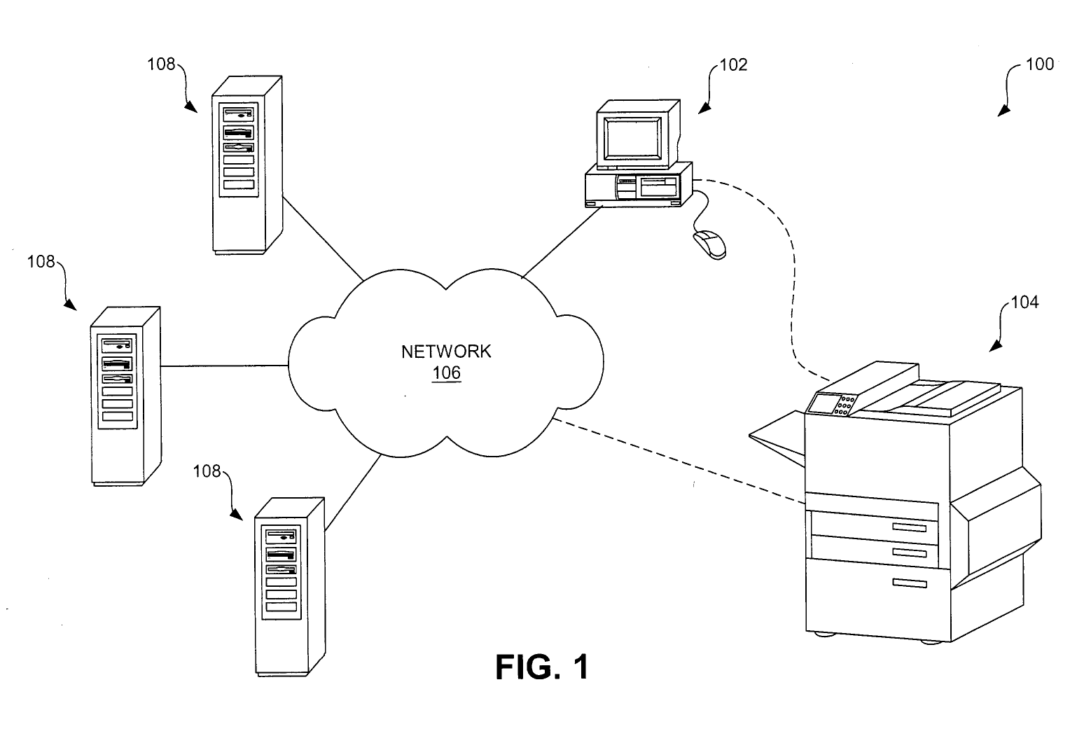

Referring now in more detail to FIG. 1, illustrated is an example system 100 with which a device user interface can be customized. As indicated in this figure, the system 100 generally comprises a host computing device 102 and an electrical device 104. As shown in FIG. 1, the host computing device 102 can, for instance, comprise a desktop personal computer (PC). However, it is to be understood that the computing device 102 can comprise substantially any device that can be used to access and/or control the electrical device 104. Therefore, the computing device 102 could, alternatively, comprise a laptop computer, personal digital assistant (PDA), mobile telephone, etc. For the purposes of this disclosure, the term “electrical device” is used to denote any device that manipulates data and which can be accessed via the host computing device 102. By way of example, the electrical device 104 can comprise a peripheral device or stand-alone appliance that is capable of generating hardcopy documents, for instance, a printer, multifunction peripheral (MFP) (sometimes referred to as an “all-in-one”), or other such printing device. Persons having ordinary skill in the art will appreciate, however, that this disclosure applies to several other types of electrical devices.

As is further identified in FIG. 1, the computing device 102 and the electrical device 104 can be connected to a network 106. The network 106 typically comprises one or more sub-networks that are communicatively coupled to each other. By way of example, these networks can include one or more local area networks (LANs) and/or wide area networks (WANs). Indeed, in some embodiments, the network 106 may comprise a set of networks that forms part of the Internet. In addition, or in exception, the computing device 102 and the electrical device 104 can be directly connected to each other. Such an arrangement is likely in a home or small office environment in which the user does not have access to a network. In such a scenario, communication can be facilitated with a direct electrical and/or optical connection (e.g., parallel port or universal serial bus (USB)), or through wireless communication (e.g., radio frequency (RF) or infrared (IR)).

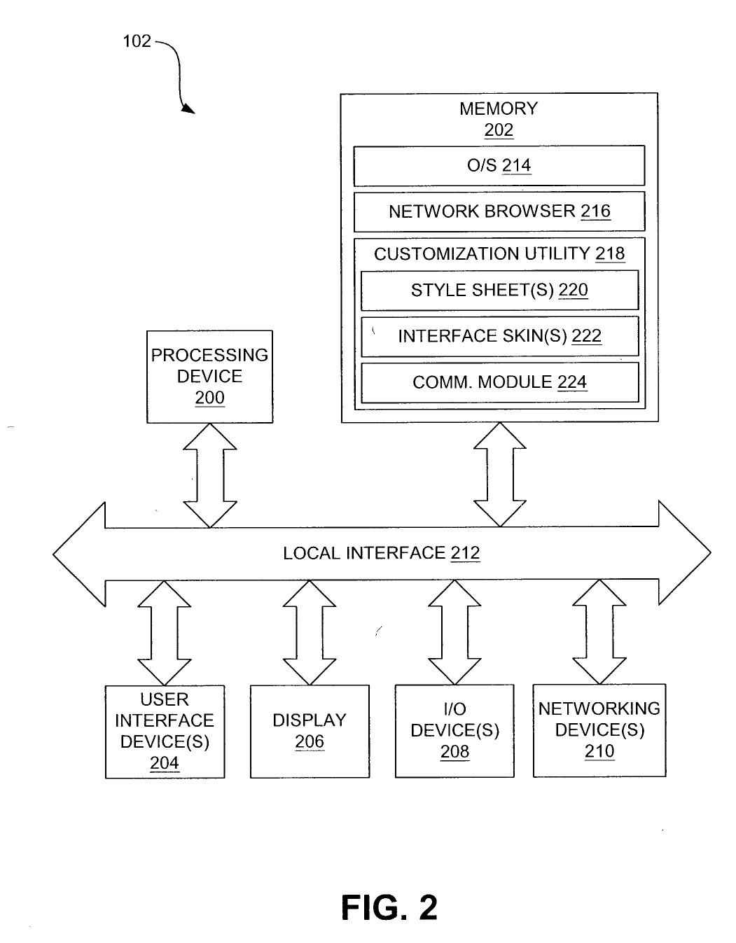

Also shown connected to the network 106 in FIG. 1 are other computing devices 108 that, for instance, comprise network servers. Example configurations for the computing devices 108 are described along those described for the host computing device 102 in relation to FIG. 2.

FIG. 2 is a block diagram illustrating an example architecture for the computing devices 102, 108 shown in FIG. 1. As indicated in FIG. 2, each computing device 102, 108 can comprise a processing device 200, memory 202, one or more user interface devices 204, a display 206, one or more I/O devices 208, and one or more networking devices 210, each of which is connected to a local interface 212. The processing device 200 can include any custom made or commercially available processor, a central processing unit (CPU) or an auxiliary processor among several processors associated with the computing device 102, a semiconductor based microprocessor (in the form of a microchip), or a macroprocessor. The memory 202 can include any one of a combination of volatile memory elements (e.g., random access memory (RAM, such as DRAM, SRAM, etc.)) and nonvolatile memory elements (e.g., ROM, hard drive, tape, CDROM, etc.).

The one or more user interface devices 204 comprise those components with which the user can interact with the computing device 102. Where the computing devices comprise PCs or similar devices, these components can comprise those typically used in conjunction with a PC such as a keyboard and mouse. Where the computing devices comprise a handheld device such as a PDA or mobile telephone, the user interface devices 204 can comprise one or more function buttons or keys. The display 206 can comprise a display typically used in conjunction with a PC such as a computer monitor or liquid crystal display (LCD) screen. Where the computing devices comprise a handheld device, the display 206 can comprise a LCD that may or may not be touch-sensitive.

The one or more I/O devices 208 comprise components used to facilitate connection of the computing devices to other devices directly, such as the electrical device 104. Therefore, these devices can, for instance, comprise one or more serial, parallel, small system interface (SCSI), universal serial bus (USB), IEEE 1394 (e.g., Firewire™), or personal area network (PAN) connection devices. The networking devices 210 comprise the various components used to transmit and/or receive data over the network 106. By way of example, the networking devices 210 include a device that can communicate both inputs and outputs, for instance, a modulator/demodulator (e g., modem), an RF or IR transceiver, a telephonic interface, a bridge, a router, as well as a network card, etc.

The memory 202 normally comprises various software programs including an operating system (O/S) 214 and a network browser 216. The O/S 214 controls the execution of other software and provides scheduling, input-output control, file and data management, memory management, and communication control and related services. The browser 216 comprises the software that is used to browse data over the network 106 or other connection served by the electrical device 104. The browser can, for example, comprise a currently available Internet browser such as Microsoft Internet Explorer™ or Netscape Navigator™.

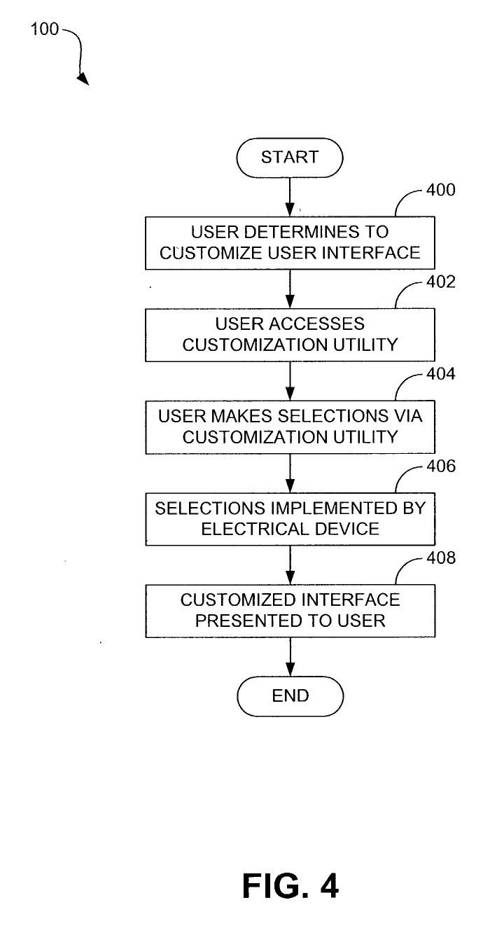

In addition to the O/S 214 and the browser 216, the memory 202 can, in some embodiments, include a host-side customization utility 218. As is described in greater detail below, the customization utility 218, where provided, can comprise a relatively simple, and therefore small, application with which device user interface content can be selected and/or arranged. The customization utility 218 may, for instance, comprise or be associated with one or more style sheets 220 and/or one or more interface skins 222 that, when implemented by the electrical device 104, customize the device user interface. Provision of the style sheets 220 and/or skins 222 to the electrical device 104 can be facilitated with a communication module 224 of the customization utility 218. Examples of operation of the customization utility 218 are provided with reference to FIG. 4 below.

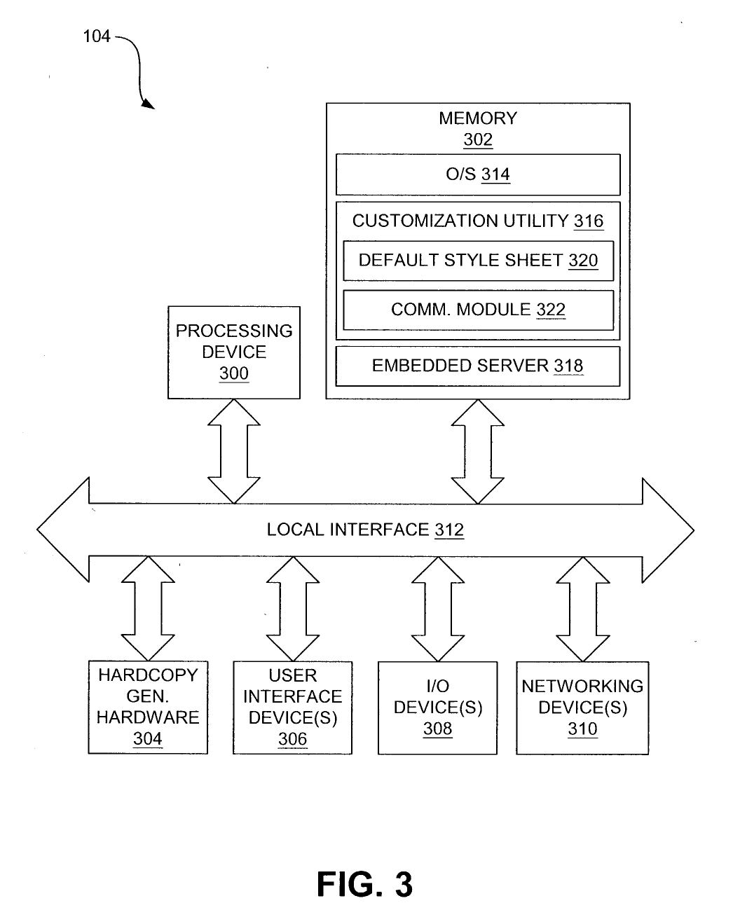

FIG. 3 is a block diagram illustrating an example architecture for the electrical device 104 shown in FIG. 1. As indicated in FIG. 3, the electrical device 104 can comprise a processing device 300, memory 302, hardcopy generation hardware 304, one or more user interface devices 306, one or more I/O devices 308, and one or more networking devices 310. Each of these components is connected to a local interface 312 that, by way of example, comprises one or more internal buses. The processing device 300 is adapted to execute commands stored in memory 302 and can comprise a general-purpose processor, a microprocessor, one or more application-specific integrated circuits (ASICs), a plurality of suitably configured digital logic gates, and other well known electrical configurations comprised of discrete elements both individually and in various combinations to coordinate the overall operation of the electrical device 104.

The hardcopy generation hardware 304 comprises the components with which the electrical device 104 can create hardcopy documents. Accordingly, this hardware 304 can comprise, for instance, a paper drive mechanism, print engine, fusing system, etc. As will be appreciated by persons having ordinary skill in the art, where the electrical device 104 is not configured as a printing device, the electrical device may not comprise the above-described hardcopy generation hardware 304 but may, instead, comprise alternative hardware that is configured to complete a functionality for which the electrical device is intended.

The one or more user interface devices 306 typically comprise minimal interface tools with which the device settings can be changed and through which the user can communicate commands to the electrical device 104. By way of example, the user interface devices 306 comprise one or more function keys and/or buttons with which the operation of the electrical device 104 can be controlled, and a display, such as a small LCD, with which some information can be visually communicated to the user. The I/O devices 308 and networking devices 310 can have configurations similar to like-named components identified above with reference to FIG. 2.

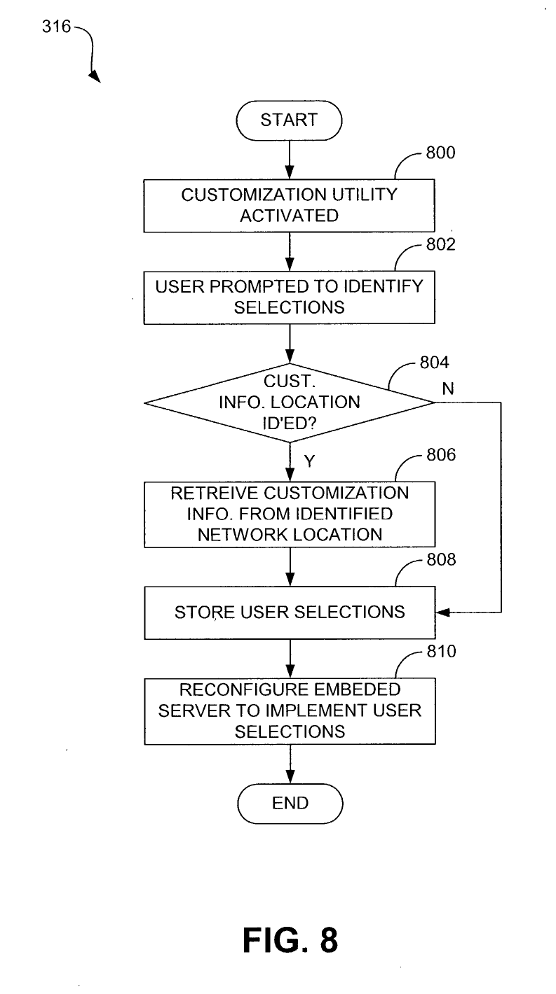

The memory 302 includes various software (e.g., firmware) programs including an operating system 314, a device-side customization utility 316, and an embedded server 318. The operating system 314 contains the various commands used to control the general operation of the electrical device 104. The customization utility 316 comprises the various code used to modify the user interface that is presented to users via the embedded server 318. By way of example, the customization utility 316 can receive information from a computing device 102, 108 that is used to modify the user interface. Alternatively, the customization utility 316 can be used to retrieve customization information via a communication module 322. In another alternative, the customization utility 316 can be accessed by the user so that the user can directly input customization information. In any case, the customization utility 316 normally comprises or is associated with a default style sheet 320. Examples of operation of the customization utility 316 are described with respect to FIG. 8 below.

Various software and/or firmware programs have been described herein. It is to be understood that these programs can be stored on any computer-readable medium for use by or in connection with any computer-related system or method. In the context of this document, a computer-readable medium is an electronic, magnetic, optical, or other physical device or means that can contain or store a computer program for use by or in connection with a computer-related system or method. These programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium include an electrical connection having one or more wires, a portable computer diskette, a random access memory (RAM), a read-only memory (ROM), an erasable programmable read-only memory (EPROM, EEPROM, or Flash memory), an optical fiber, and a portable compact disc read-only memory (CDROM). Note that the computer-readable medium can even be paper or another suitable medium upon which a program is printed, as the program can be electronically captured, via for instance optical scanning of the paper or other medium, then compiled, interpreted or otherwise processed in a suitable manner if necessary, and then stored in a computer memory.

Example systems having been described above, system operation will now be discussed. In the discussion that follows, flow diagrams are provided. It is to be understood that any process steps or blocks in these flow diagrams may represent modules, segments, or portions of code that include one or more executable instructions for implementing specific logical functions or steps in the process. It will be appreciated that, although particular example process steps are described, alternative implementations are feasible. Moreover, steps may be executed out of order from that shown or discussed, including substantially concurrently or in reverse order, depending on the functionality involved.

As noted above, the system 100 can be used to facilitate customization of the electrical device user interface accessed with a browser. A high-level example of the operation of the system 100 in providing for such customization is illustrated in FIG. 4. Beginning with block 400 of this figure, the user first determines to customize the device user interface. Once this determination is made, the user accesses a customization utility, whether it be that of one of the computing devices 102, 108, or that of the electrical device 104, as indicated in block 402. Next, the user makes his or her customization selections, as indicated in block 404 using the customization utility. These selections can comprise selections as to what content is presented and/or as to the arrangement of the content that will be presented.

After the selections are made, the selections are implemented by the electrical device 104, as indicated in block 406. Once implemented, the user can be presented with a customized user interface, as indicated in block 408, when the user browses to the embedded server 318 of the electrical device 104.

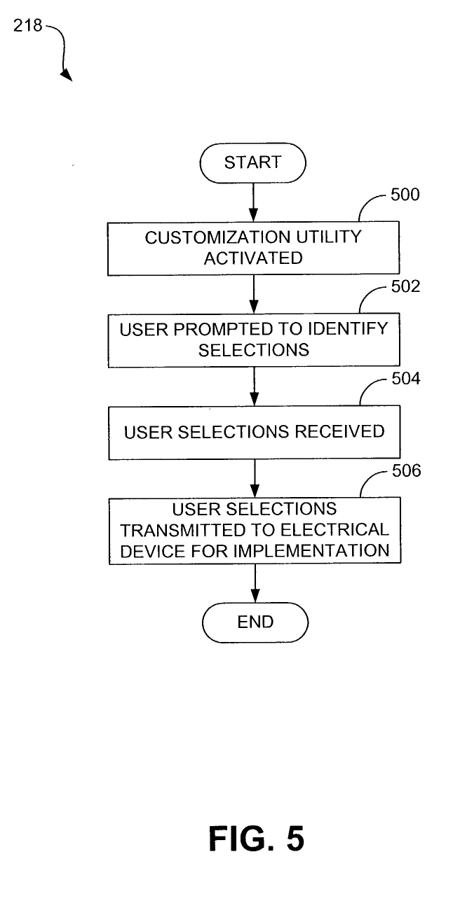

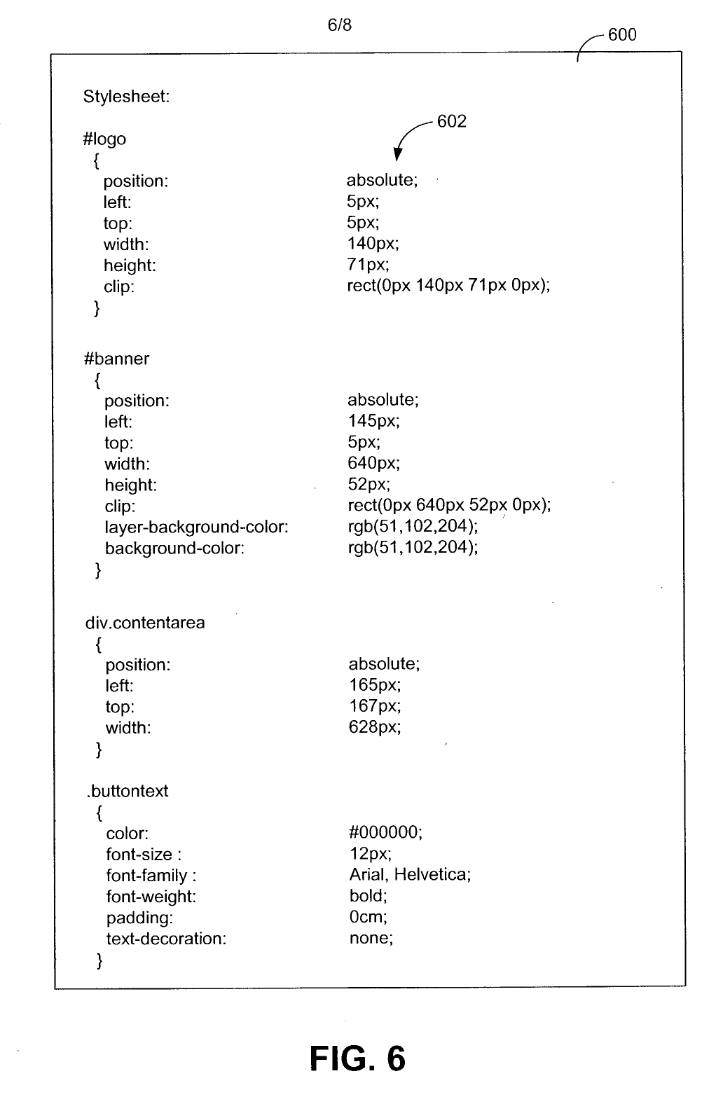

FIG. 5 provides an example of operation of the host-side customization utility 218 in facilitating customization of the user interface. Beginning with block 500 of this figure, the customization utility 218 is activated. This activation can, for instance, occur when the user selects an appropriate icon or menu item presented to the user with the computing device display 206. Once the customization utility 218 is activated, the user can be prompted to identify the selections that will, in some manner, customize the device user interface, as indicated in block 502. By way of example, the user can be presented with a style sheet that comprises one or more fields that will be accessed by the device embedded server 318 when generating a page to be presented to the user, and prompted to modify the style sheet. An example of one such style sheet 600 is provided in FIG. 6. As indicated in this figure, the style sheet 600 comprises a plurality of fields 602 that, when stored in the proper location in device memory 302, are referred to by the server 318 by one or more tags included in the code (e.g., hypertext mark-up language (HTML)) that defines the one or more interface pages that the server generates. As is known in the art, the style sheet 600 may be broken down into various sections pertinent to various portions of one or more interface pages (e.g., a “logo”). Details may be specified about the arrangement of each portion (i.e., each piece of content) in the style sheet. For instance, as indicated in FIG. 6, the width of a displayed logo can be 140 pixels (px). By prompting the user to change the fields 602, the user can be prompted to alter the user interface.

In another example, the user can be prompted to simply enter selections in various fields presented by the customization utility 218. For instance, the user can be given the opportunity to identify the location of various display content on the page by entering or selecting “left side” or “right side” choices. Such a scheme may provide the user with less flexibility, but may be more appealing for less savvy users. In a further example, the user can be prompted to identify the location of content to be added to the user interface and/or used to replace existing content. For instance, where a given logo (e.g., the logo of the device manufacturer) is presented by default on one or more user interface pages, the user can identify the network address (e.g., universal resource locator (URL)) of a different logo (e.g., of the user's company) to replace the original logo.

In yet another example, the user can be provided with the option to select one of several different “skins” that modify the look and feel of the user interface. The skins can be theme-based, for instance having the look and feel of a plane cockpit, being arranged with cartoon animals for children, etc. The skins can be stored in, for instance, a ZIP file within memory 202 (e.g., skin(s) 222) that can be provided to the electrical device 104, opened by the device, and the various files of the ZIP file stored in appropriate locations by the electrical device.

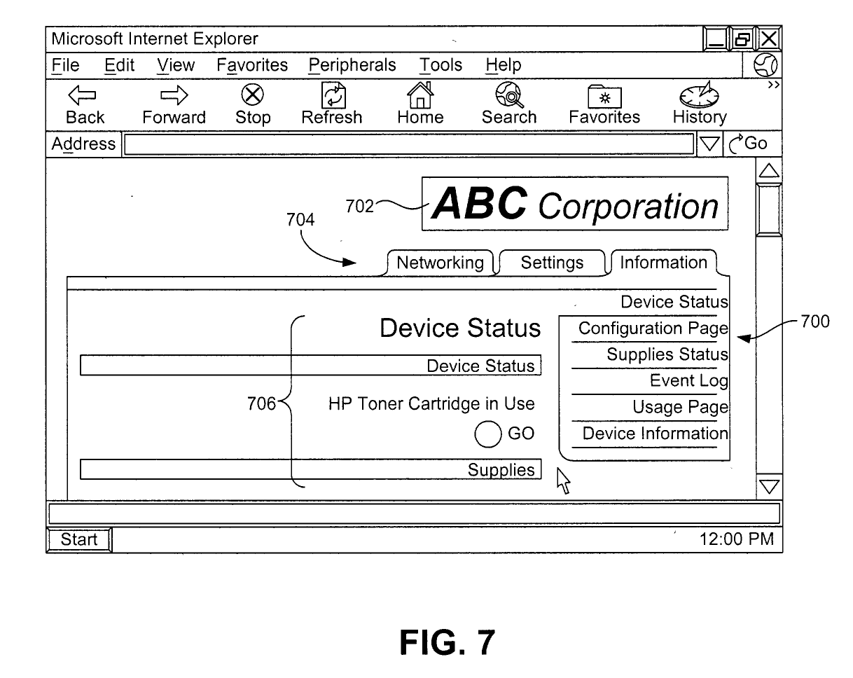

Irrespective of the nature of the selections, the selections can be received, as indicated in block 504, and then transmitted to the electrical device 104 for implementation, as indicated in block 506. FIG. 7 illustrates an example customized user interface 700 in which a left-aligned manufacturer logo has been replaced with a right-aligned company logo 702. In addition, various tabs 704 have been moved to a light-aligned arrangement, and various other text 706 has been adjusted to a right-aligned format.

FIG. 8 provides an example of operation of the device-side customization utility 316 in facilitating customization of the user interface. Beginning with block 800, the customization utility 316 is activated. This activation can, for instance, occur when the user browses to the embedded server 318 of the electrical device 104 using his or her browser 216 and selects a “customize” tab, button, icon, or menu item presented on one or more of the pages of the user interface. Once the customization utility 316 is activated, the user can, in similar fashion to that described above in relation to the host-side customization utility 218, be prompted to identify the selections that will customize the device user interface, as indicated in block 802. Again, the user can be prompted to identify the selections directly to the customization utility by, for instance, modifying a style sheet, entering information in one or more presented fields, selecting from a group of available interface skins, etc. Alternatively, the user can be prompted to provide the location of customization information that is to be used to customize the user interface. For instance, the user can be prompted to identify the network location (e.g., identified with a URL) of a replacement style sheet that is to be used by the server 318 when generating pages, the network location of an interface skin to be used when generating pages, the location of content that is to be added to the user interface, etc.

Next, with reference to decision element 804, it can be determined whether the location of customization information (content and/or arrangement information) has been provided to the customization utility 316. If not, flow continues down to block 808 described below. If, on the other hand, a location has been identified, the customization information is retrieved, as indicated in block 806. Once this information is retrieved (or if no location had been identified), flow continues to block 808 at which the various customization selections (including any new content, if any) are stored by the customization utility 316.

The customization utility 316 of the electrical device 104 can then reconfigure the embedded server 318 to implement the various selections/information identified by the user, as indicated in block 810. This reconfiguration may depend upon the nature of the selections that the user made. For instance, where the user provided, or identified the location of, a replacement style sheet, the server 318 is reconfigured to refer to the new style sheet (as opposed to the default style sheet) when pages of the user interface are generated. This can be accomplished by adding/modifying an appropriate reference to the server code that causes the server 318 to consult the new style sheet (or content, etc.). Through this reconfiguration, the server 318 will then be able to present a customized user interface to the user(s).

While particular embodiments of the invention have been disclosed in detail in the foregoing description and drawings for purposes of example, it will be understood by those skilled in the art that variations and modifications thereof can be made without departing from the scope of the invention as set forth in the following claims.

What is claimed is:

1. A method for facilitating customization of an electrical device user interface, comprising:
receiving a device interface selection; and
facilitating implementation of the selection such that a customized electrical device user interface is presented to a user when accessing the interface via a browser executing on a separate electrical device.

2. The method of claim 1, wherein the step of receiving comprises receiving modifications to a style sheet that is to be used by an electrical device server in generating one or more interface pages.

3. The method of claim 1, wherein the step of receiving comprises receiving an identification of the location of a style sheet that is to be used by an electrical device server in generating one or more interface pages.

4. The method of claim 1, wherein the step of receiving comprises receiving an identification of the location of content to be added to one or more interface pages generated by an electrical device server.

5. The method of claim 1, wherein the step of receiving comprises receiving an identification of the location of an interface skin that is to be used by an electrical device server in generating one or more interface pages.

6. The method of claim 1, wherein the step of receiving comprises directly receiving a selection as to at least one of the placement of content on an interface page and an interface skin.

7. The method of claim 1, wherein the step of facilitating implementation comprises downloading at least one of a replacement style sheet, new content, and an interface skin that is to be used to generate one or more interface pages.

8. The method of claim 1, wherein the step of facilitating implementation comprises retrieving at least one of a replacement style sheet, new content, and an interface skin that is to be used to generate one or more interface pages.

9. The method of claim 1, wherein the step of facilitating implementation comprises reconfiguring code used by a device server to generate one or more interface pages to incorporate the user selection.

10. A system for facilitating customization of a network-based device user interface, comprising:
means for prompting a user to make a device interface customization selection that pertains to content to be provided in the device interface;
means for receiving the device interface customization selection made by the user; and
means for facilitating implementation of the user selection such that a customized device user interface is presented to a user when accessing the interface via a browser.

11. The system of claim 10, wherein the means for receiving comprise means for receiving style sheet adjustments that are to be used by an electrical device server in generating the device interface.

12. The system of claim 10, wherein the means for receiving comprise means for receiving an identification of at least one of the location of a style sheet, content, and an interface skin that is to be used by an electrical device server in generating one or more interface pages.

13. The system of claim 10, wherein the means for facilitating implementation comprise means for downloading at least one of a replacement style sheet, new content, and an interface skin that is to be used to generate one or more interface pages.

14. The system of claim 10, wherein the means for facilitating implementation comprise means for retrieving at least one of a replacement style sheet, new content, and an interface skin that is to be used to generate one or more interface pages.

15. The system of claim 10, wherein the means for facilitating implementation comprise means for reconfiguring code used by a device server to generate one or more interface pages to incorporate the user selection.

16. A host-side customization utility stored on a computer-readable medium, comprising:
logic configured to receive user customization selections regarding a browser-accessible, electrical device user interface; and
logic configured to transmit the user customization selections to an electrical device for downloading by the electrical device such that the selections will be implemented when one or more interface pages are generated by a server of the electrical device.

17. The customization utility of claim 16, wherein the logic configured to receive user customization selections comprises logic configured to receive modifications made to a style sheet presented to the user.

18. The customization utility of claim 16, wherein the logic configured to receive user customization selections comprises logic configured to receive identification of content to be added to the one or more interface pages.

19. The customization utility of claim 16, wherein the logic configured to receive user customization selections comprises logic configured to receive identification of an interface skin to be used by the electrical device server when generating the one or more interface pages.

20. A device-side customization utility stored on a computer-readable medium, comprising:
logic configured to receive user customization selections regarding a browser-accessible, electrical device user interface; and
logic configured to reconfigure code used by an electrical device server to generate one or more interface pages to implement the user customization selections.

21. The customization utility of claim 20, wherein the logic configured to receive user customization selections comprises logic configured to receive modifications made to a style sheet presented to the user.

22. The customization utility of claim 20, wherein the logic configured to receive user customization selections comprises logic configured to receive the location of a replacement style sheet to be used by the electrical device server in generating the one or more interface pages.

23. The customization utility of claim 20, wherein the logic configured to receive user customization selections comprises logic configured to receive identification of the location of content to be added to the one or more interface pages.

24. The customization utility of claim 20, wherein the logic configured to receive user customization selections comprises logic configured to receive identification of an interface skin to be used by the electrical device server when generating the one or more interface pages.

25. The customization utility of claim 20, wherein the logic configured to receive user customization selections comprises logic configured to receive identification of the location of an interface skin to be used by the electrical device server when generating the one or more interface pages.

26. A method for customizing a browser-accessible electrical device user interface, comprising:
downloading a replacement style sheet that is to be used in lieu of a default style sheet, the replacement style sheet specifying the layout of content presented in the electrical device user interface; and
configuring code used to generate one or more interface pages such that an embedded browser of an electrical device will implement the layout specified in the replacement style sheet when the one or more interface pages are generated.

27. The method of claim 26, wherein the downloading occurs when the replacement style sheet is transmitted to the electrical device from a host device.

28. The method of claim 26, wherein the downloading occurs when the replacement style sheet is retrieved upon receiving an identification of the location of the replacement style sheet.

29. The method of claim 26, further comprising downloading new content to be presented in the one or more interface pages.

30. The method of claim 29, wherein the downloading of new content occurs when the content is transmitted to the electrical device from a host device.

31. The method of claim 29, wherein the downloading of new content occurs when the content is retrieved upon receiving an identification of the location of the content.

32. A device-side customization utility for customizing a browser-accessible electrical device user interface, the customization utility being stored on a computer-readable medium, comprising:
logic configured to download a replacement style sheet that is to be used in lieu of a default style sheet, the replacement style sheet specifying the layout of content presented in the electrical device user interface; and
logic configured to configure code used to generate one or more interface pages such that an embedded server of an electrical device will implement the layout specified in the replacement style sheet when the one or more interface pages are generated.

33. The customization utility of claim 32, further comprising logic configured to download new content to be presented in the one or more interface pages.

34. An electrical device, comprising:
a processing device; and
memory, the memory including an embedded server and a customization utility, the customization utility including:
logic configured to receive user selections regarding a browser-accessible, electrical device user interface, and
logic configured to reconfigure code used by an electrical device server to generate one or more interface pages.

35. The device claim 34, wherein the logic configured to receive user selections comprises logic configured to receive modifications made to a style sheet presented to the user.

36. The device of claim 34, wherein the logic configured to receive user selections comprises logic configured to receive the location of a replacement style sheet to be used by the electrical device server in generating the one or more interface pages.

37. An electrical device, comprising:
a processing device; and
memory, the memory including an embedded server and a customization utility, the customization utility including:
logic configured to download a replacement style sheet that is to be used in lieu of a default style sheet, the replacement style sheet specifying the layout of content presented in the electrical device user interface, and
logic configured to reconfigure code used to generate one or more interface pages such that an embedded browser of an electrical device will implement the layout specified in the replacement style sheet when the one or more interface pages are generated.

38. The device of claim 37, wherein the customization utility further includes logic configured to download new content to be presented in the one or more interface pages.
